(19) United States
(12) Patent Application Publication
(10) Pub. No.: US 2020/0101597 A1
(43) Pub. Date: Apr. 2, 2020

(54) DRIVE MECHANISM OF ROBOT AND ROBOT

(71) Applicant: Fanuc Corporation, Yamanashi (JP)

(72) Inventor: Kunihiko MURAKAMI, Yamanashi (JP)

(73) Assignee: Fanuc Corporation, Yamanashi (JP)

(21) Appl. No.: 16/567,465

(22) Filed: Sep. 11, 2019

(30) Foreign Application Priority Data
Sep. 28, 2018 (JP) 2018-183351

(51) Int. Cl. B25J 9/12; B25J 19/00; B25J 9/00; B25J 17/00; B25J 9/02

(52) U.S. Cl. CPC B25J 9/126; B25J 19/0029; B25J 9/02; B25J 17/00; B25J 9/0024

(57) ABSTRACT

A drive mechanism of a robot includes a first member, a second member which is supported by the first member and which is rotatable with respect to the first member about a vertical axis line, a main drive motor which is fixed to one of the first member and the second member, a main drive reducer which reduces rotation of the main drive motor and transmits the reduced rotation to the other one of the first member and the second member, and an auxiliary torque generator which constantly applies an unidirectional torque about an axis line A to the second member with respect to the first member.

### CROSS-REFERENCE TO RELATED APPLICATIONS

This application is based on and claims priority to Japanese Patent Application No. 2018-183351 filed on Sep. 28, 2018, the content of which is incorporated herein by reference in its entirety.

### TECHNICAL FIELD

The present invention relates to a drive mechanism of a robot and the robot.

### BACKGROUND ART

Conventionally, as a drive mechanism of an arm which is driven about a horizontal axis line, a drive mechanism including not only a motor and a reducer, but also a balancer for lightening a burden caused by the gravity acting on the arm at all times in order to rotatably drive the arm about the horizontal axis line with respect to a member which supports the arm is known. (See PTL 1, for example.)

In the drive mechanism of the arm on which the gravity acts as described above, engagement of gears in the reducer is caused to be one-sided in either one of directions over a substantially entire operation region due to the gravity, the balancer, or the like, and therefore, backlash between the gears is eliminated, and rotation angle difference between a rotation shaft of a motor and an output shaft of the reducer is hardly generated.

### CITATION LIST

### Patent Literature

### {PTL 1}

Japanese Unexamined Patent Application, Publication No. 2005-319550

### SUMMARY OF INVENTION

An aspect of the present invention is a drive mechanism of a robot including a first member; a second member which is supported by the first member and which is rotatable with respect to the first member about a vertical axis line; a main drive motor which is fixed to one of the first member and the second member; a main drive reducer which reduces rotation of the main drive motor and transmits the reduced rotation to the other one of the first member and the second member; and an auxiliary torque generator which constantly applies an unidirectional torque about the vertical axis line to the second member with respect to the first member.

### BRIEF DESCRIPTION OF DRAWINGS

FIG. 1 is an overall configuration view showing an example of a robot according to an embodiment of the present invention.

FIG. 2 is a longitudinal sectional view showing an example of a drive mechanism according to the embodiment of the present invention provided in the robot in FIG. 1.

### DESCRIPTION OF EMBODIMENTS

A drive mechanism 1 of a robot 100 and the robot 100 according to a first embodiment of the present invention will be described below with reference to the accompanying drawings.

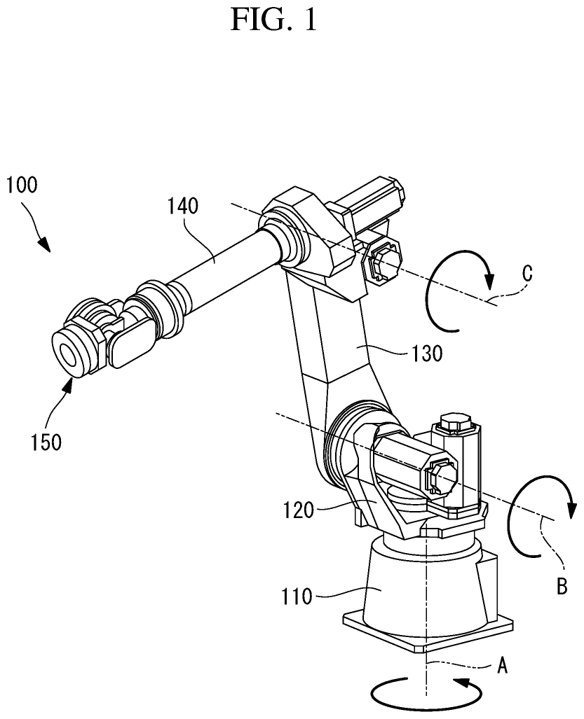

As shown in FIG. 1, the robot 100 according to this embodiment is a six-axis articulated robot which includes a base 110 which is installed on a floor surface, a turning drum 120 which is supported by the base 110 and which is rotatable with respect to the base 110 about a first axis line A which extends in a vertical direction, a first arm 130 which is supported by the turning drum 120 and which is rotatable with respect to the turning drum 120 about a second axis line B which extends in a horizontal direction, a second arm 140 which is supported by the first arm 130 and which is rotatable with respect to the first arm 130 about a third axis line C which is parallel to the second axis line B, and a three-axis wrist unit 150 which is supported at a distal end of the second arm 140.

The drive mechanism 1 of the robot 100 according to this embodiment is a drive mechanism of the first axis which rotates the turning drum 120 with respect to the base 110. This drive mechanism 1 includes a base (a first member) 110, a turning drum (a second member) 120 which is supported by the base 110 and which is rotatable about a first axis line (an axis line) A with respect to the base 110, a first axis motor (a main drive motor) 2 which is fixed to the turning drum 120, a first axis reducer (a main drive reducer) 3 which reduces speed of rotation of the first axis motor 2, and an auxiliary torque generator 4.

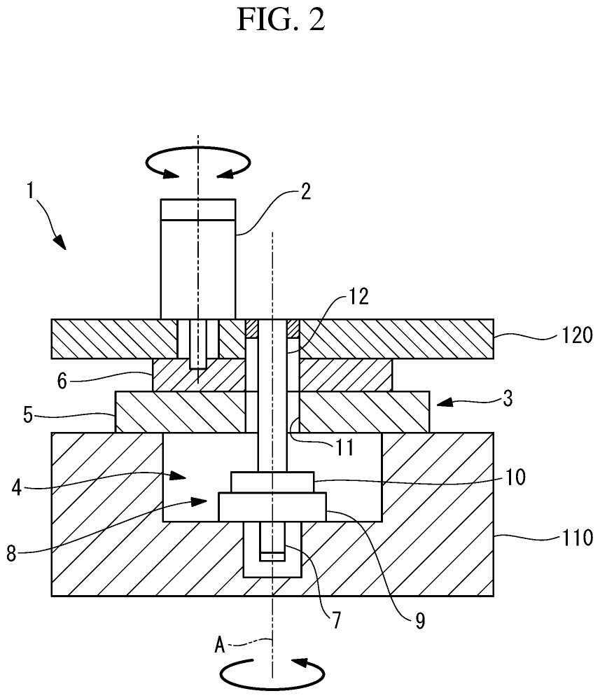

As shown in FIG. 2, the first axis reducer 3 includes a fixed casing 5 which is fixed to the base 110, and an output shaft 6 which is supported by the fixed casing 5 and which is rotatable about the first axis line A with respect to the fixed casing 5, and the output shaft 6 is fixed to the turning drum 120. The first axis reducer 3 includes a plurality of gears inside thereof, which are not shown in the drawings. The rotation of the first axis motor 2 is transmitted to the inside of the first axis reducer 3 through gears, and the speed of rotation of the first axis motor 2 is reduced by reduction ratio which is in response to the gear ratio of the plurality of the gears so as to be transmitted to the output shaft 6. By this, a torque of the first axis motor 2 is amplified in response to the reduction ratio so as to be input to the turning drum 120 from the output shaft 6, which causes the turning drum 120 to rotate about the first axis line A.

As shown in FIG. 2, the auxiliary torque generator 4 includes an auxiliary motor (a secondary drive motor) 7 which is fixed to the base 110, and an auxiliary reducer (a secondary drive reducer) 8 which reduces the speed of rotation of the auxiliary motor 7. The auxiliary reducer 8 also includes a fixed casing 9 and an output shaft 10, and the fixed casing 9 is fixed to the base 110.

The output shaft 10 is fixed to the turning drum 120 through a connection shaft 12 penetrating through a central hole 11 which penetrates through a center of the first axis reducer 3 along the first axis line A. The auxiliary motor 7 generates an unidirectional torque about the first axis line A at all times.

Operation of the drive mechanism 1 of the robot 100 and the robot 100 according to this embodiment, which are configured as described above, will be explained below.

With the drive mechanism 1 of the robot 100 according to this embodiment, a torque which is generated unidirectionally about the first axis line A by the operation of the auxiliary torque generator 4 is applied to the turning drum 120 so that the turning drum 120 is caused to operate in the same situation with the first arm 130 which receives a torque generated by the gravity at all times.

That is to say, in such a case where a direction of the torque generated by the first axis motor 2 and the first axis reducer 3 is the same as the direction of the torque which is generated by the auxiliary torque generator 4, an amount of the torque which should be generated by the first axis motor 2 becomes small, however, in such a case where the direction of the torque generated by the first axis motor 2 and the first axis reducer 3 is opposite to that of the torque which is generated by the auxiliary torque generator 4, it is necessary to generate a larger torque. And, in order to stop the turning drum 120 at a predetermined position, it is necessary to cause the first axis motor 2 to keep generating a torque with the same magnitude as the torque which is generated by the auxiliary torque generator 4 in a direction which is opposite to that of the torque generated by the auxiliary torque generator 4, or to stop the turning drum 120 by using a brake.

The auxiliary torque generator 4 keeps generating the torque in the same direction at all times in the above described manner, and therefore, even when backlash exists engagement of the plurality of the gears in the first axis reducer 3, the engagement of the gears is caused to be one-sided in either one of the directions so that the backlash of the first axis reduce 3 is eliminated, and rotation angle difference between the first axis motor 2 and the output shaft of the first axis reducer 3 can be reduced, which are advantageous.

Especially, with the robot 100 according to this embodiment, by eliminating the backlash of the first axis reducer 3, it is possible to improve accuracy of an operation trajectory of the distal end of the robot 100 even when the distal end of the three-axis wrist unit 150 is most distant from the first axis line A in such a state where the first arm 130 and the second arm 140 are extended at a maximum degree, which is advantageous.

Also, this embodiment shows an example in which the first axis motor 2 is fixed to the turning drum 120, however, the first axis motor 2 may be fixed to the base 110.

And, the direction of the torque which is applied by the auxiliary torque generator 4 may be an opposite direction. Moreover, in addition to a case where the auxiliary torque generator 4 keeps generating a constant amount of torque at all times, the magnitude of the torque generated by the auxiliary torque generator 4 can be changed in response to the torque generated by the first axis motor 2.

That is to say, in such a case where the direction of the torque which is applied by the auxiliary torque generator 4 and that of the torque which is generated by the first axis motor 2 are different from each other, since the torque which is applied from the auxiliary torque generator 4 is a burden to the first axis motor 2, the magnitude of the torque may be reduced in order to reduce the burden.

In addition, in this embodiment, as an example of the auxiliary torque generator 4, the one having the auxiliary motor 7 and the auxiliary reducer 8 is shown, however, instead of this, an auxiliary torque generator, which applies an unidirectional torque about the first axis line A to the turning drum 120 at all times by using resilient force of a spring, such as a spiral spring, a compression coil spring, and the like, may be adopted.

And, this embodiment shows the six-axis articulated robot as an example, however, the above described configuration can be adopted to any type of a robot having an shaft which is rotatably driven about an axis line extending in the vertical direction.

The following aspects of the present invention are derived from the above disclosure.

An aspect of the present invention is a drive mechanism of a robot including a first member; a second member which is supported by the first member and which is rotatable with respect to the first member about a vertical axis line; a main drive motor which is fixed to one of the first member and the second member; a main drive reducer which reduces rotation of the main drive motor and transmits the reduced rotation to the other one of the first member and the second member; and an auxiliary torque generator which constantly applies an unidirectional torque about the vertical axis line to the second member with respect to the first member.

According to this aspect, the main drive reducer reduces rotation of the main drive motor which is fixed to one of the first member and the second member so as to transmit the reduced rotation to the other one of the first member and the second member, and therefore, the torque of the main drive motor is amplified, and the second member is driven so as to rotate about a vertical axis line with respect to the first member. Also, by operation of the auxiliary torque generator, the unidirectional torque about the vertical axis line is constantly applied to the second member with respect to the first member. By this, even when backlash exists between the gears in the main drive reducer, the torque which is generated by the auxiliary torque generator causes an engagement of the gears to be one-sided in either one of directions so that the backlash of the main drive reducer is eliminated, and rotation angle difference between the main drive motor and the output shaft of the main drive reducer is reduced, which improves accuracy of an operation trajectory of the robot.

In the above aspect, the auxiliary torque generator may include a secondary drive motor which is fixed to one of the first member and the second member; and a secondary drive reducer which reduces rotation of the secondary drive motor and transmits the reduced rotation to the other one of the first member or the second member.

Due to this configuration, by unidirectionally driving the secondary drive motor, and reducing the speed of rotation of the secondary drive motor by using the secondary drive reducer, it is possible to constantly apply the unidirectional torque to the second member with respect to the first member in a simplified manner.

Also, another aspect of the present invention is a robot having any one of the above described drive mechanisms.

According to the above aspects, it is possible to reduce rotation angle difference generated in a drive mechanism which is driven about a vertical axis line, and to improve accuracy of an operation trajectory of a robot.

### REFERENCE SIGNS LIST

1 drive mechanism
2 first axis motor (main drive motor)
3 first axis reducer (main drive reducer)
4 auxiliary torque generator
7 auxiliary motor (secondary drive motor)
8 auxiliary reducer (secondary drive reducer)
100 robot
110 base
120 turning drum
A first axis line (axis line)

1. A drive mechanism of a robot comprising:
a first member;
a second member which is supported by the first member and which is rotatable with respect to the first member about a vertical axis line;
a main drive motor which is fixed to one of the first member and the second member;
a main drive reducer which reduces rotation of the main drive motor and transmits the reduced rotation to the other one of the first member and the second member; and
an auxiliary torque generator which constantly applies an unidirectional torque about the vertical axis line to the second member with respect to the first member.

2. The drive mechanism of the robot according to claim 1, wherein the auxiliary torque generator includes:
a secondary drive motor which is fixed to one of the first member and the second member; and
a secondary drive reducer which reduces rotation of the secondary drive motor and transmits the reduced rotation to the other one of the first member or the second member.

3. A robot comprising:
the drive mechanism according to claim 1.
